(19) United States
(12) Patent Application Publication
(10) Pub. No.: US 2009/0140976 A1
(43) Pub. Date: Jun. 4, 2009

(54) DISPLAY APPARATUS AND METHOD OF DRIVING THE SAME

(76) Inventors: Jae-Sung BAE, Cheonan-si (KR); Jung-Hwan Cho, Gongyang-si (KR)

Correspondence Address: Haynes and Boone, LLP;IP Section, 2323 Victory Avenue, SUITE 700, Dallas, TX, 75219, US

(21) Appl. No.: 12/243,818

(22) Filed: Oct. 1, 2008

(30) Foreign Application Priority Data
Nov. 29, 2007 (KR) 10-2007-123007

(51) Int. Cl. G09G 3/36

(52) U.S. Cl. 345/103

(57) ABSTRACT

In a display apparatus, an interface unit receives N image signal groups each including i×j image signals from an external video system, wherein N is a natural number equal to or greater than 2. A display panel includes data lines, gate lines, and pixels to display images. The display panel includes N display areas each having a resolution of i×j, and the N display areas are extended along a vertical direction and sequentially arranged along a horizontal direction. The N display areas display the images corresponding to the N image signal groups input through the N interface units, respectively. Thus, although the display apparatus has an ultra high-definition resolution, a frequency for transmission of the image signals may be prevented from being increased, so that no additional memories are required.

### CROSS-REFERENCE TO RELATED APPLICATION

This application relies for priority upon Korean Patent Application No. 10-2007-123007 filed on Nov. 29, 2007 in the Korean Intellectual Property Office, the contents of which are herein incorporated by reference in their entirety.

### BACKGROUND OF THE INVENTION

1. Field of the Invention

The present invention relates to a display apparatus and a method of driving the display apparatus. More particularly, the present invention relates to a display apparatus that displays images using an image display method suitable for ultra high-definition resolutions and a method of driving the display apparatus.

2. Description of the Related Art

In general, a liquid crystal display includes a display panel that displays images thereon and a driving circuit that drives the display panel. The display panel includes a plurality of pixels, a plurality of gate lines, and a plurality of data lines. The gate and data lines apply a gate signal and a data signal, respectively, from the driving circuit to the pixels.

The liquid crystal display further includes a timing controller that receives image signals from an external video system and applies image signals and various control signals to the driving circuit after signal processing of the image signals. The timing controller receives the image signals from the external video system through an interface unit.

In accordance with the development of liquid crystal display technology, the resolution of display panels gradually increases over time. In order to drive a display panel having a full high-definition (FHD) resolution of 1920×1080, an interface unit that supports 124 MHz is required since the image signals are transmitted at 124 MHz.

However, in recent applications, display panels having ultra high-definition resolution have been researched and developed for use in theaters or with projectors. Accordingly, ultra high-definition resolution display panels have resolutions of 3840×2160 or 4096×2160. For display panels having the above-mentioned resolutions, an interface unit is required to transmit image signals at 500 MHz.

### SUMMARY OF THE INVENTION

The present invention provides a display apparatus capable of driving a display panel having an ultra high-definition resolution without increasing the number of interface units and memories.

The present invention also provides a method of driving the display apparatus.

In accordance with one aspect of the present invention, a display apparatus includes an interface unit that receives N image signal groups and a display panel, wherein N is a natural number equal to or greater than 2. The interface unit receives N image signal groups each including i×j image signals from an external video system, respectively. The display panel includes a plurality of data lines, a plurality of gate lines, and a plurality of pixels to display an image. The display panel is divided into N display areas each having a resolution of i×j, and the N display areas display data signals corresponding to the N image signal groups input through the N interface units. The N display areas are sequentially arranged along a direction in which the gate lines are extended.

In another aspect of the present invention, a method of driving a display apparatus is provided. When N image signal groups each including i×j image signals in parallel are input, the N image signal groups are converted into N data signal groups. The N data signal groups are applied to N display areas each having a resolution of i×j, respectively. When a gate signal is sequentially applied to the N display areas, images corresponding to the N data signal groups are simultaneously displayed in the N display areas, respectively, in response to the gate signal.

According to the above, in order to drive the display panel having an ultra high-definition resolution, the display panel is divided into N display areas along a scanning direction of the gate lines. Also, the image signals are applied to each of the display areas through the independent interface units, respectively.

### BRIEF DESCRIPTION OF THE DRAWINGS

The above and other advantages of the present invention will become readily apparent by reference to the following detailed description when considered in conjunction with the accompanying figures wherein:

FIG. 1 is a block diagram showing an exemplary embodiment of a display apparatus according to the present invention;

FIG. 2 is a block diagram showing the interface unit and video system of FIG. 1; and

FIG. 3 is a block diagram showing a connection between a display unit and an interface unit of FIG. 1.

### DESCRIPTION OF THE EMBODIMENTS

It will be understood that when an element or layer is referred to as being “on”, “connected to” or “coupled to” another element or layer, it can be directly on, connected to or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as is commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

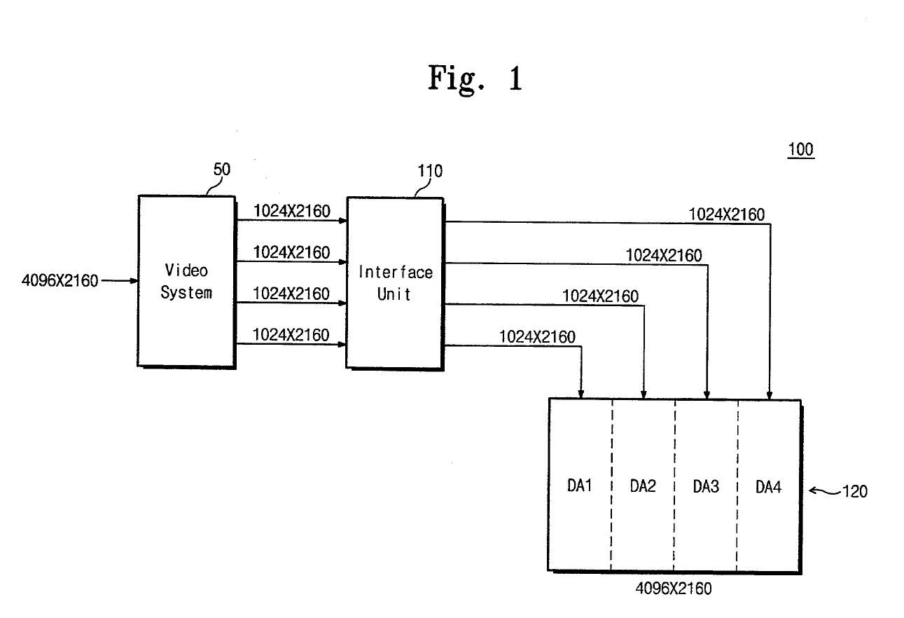

FIG. 1 is a block diagram showing an exemplary embodiment of a display apparatus according to the present invention.

Referring to FIG. 1, a display apparatus 100 includes an interface unit 110 that receives image signals from an external video system 50 and a display unit 120 that displays images based on the image signals provided from the interface unit 110.

The display unit 120 includes a display panel having a resolution of (n×i)×j. In the present exemplary embodiment, “n×i” is 4096 and “j” is 2160. In order to display the images on the display panel, the video system 50 applies 4096×2160 image signals to the interface unit 110. The video system 50 divides the 4096×2160 image signals into N image signal groups each including 1024×2160 image signals. The N image signals groups are applied to the interface unit 110.

As an example of the present invention, N may be a natural number that is equal to or greater than 2, and an example that N is 4 is described below as a representative exemplary embodiment with reference to FIG. 1. Thus, the video system 50 divides the 4096×2160 image signals into four equal groups and applies four image signal groups each including 1024×2160 image signals to the interface unit 110.

Also, in the present exemplary embodiment, the video system 50 and the interface unit 110 transmit and receive data therebetween through a low-voltage differential signaling (LVDS) interface type.

The display panel having the resolution of 4096×2160 of the display unit 120 is divided into four equal areas such as a first display area DA1, a second display area D2, a third display area D3, and a fourth display area D4. Particularly, in the display panel having the resolution of 4096×2160, 4096 pixels are arranged along a horizontal direction for every row and 2160 pixels are arranged along a vertical direction for every column. When the display panel is divided into four equal areas along the vertical direction, 1024 pixels are arranged along the horizontal direction for every row and 2160 pixels are arranged along the vertical direction for every column in each of the first, second, third, and fourth display areas DA1, DA2, DA3, and DA4. Consequently, each of the first, second, third, and fourth display areas DA1, DA2, DA3, and DA4 has a resolution of 1024×2160.

The four image signal groups each including 1024×2160 image signals output from the interface unit 110 are applied to the display unit 120 and displayed in the first, second, third, and fourth display areas DA1, DA2, DA3, and DA4, respectively.

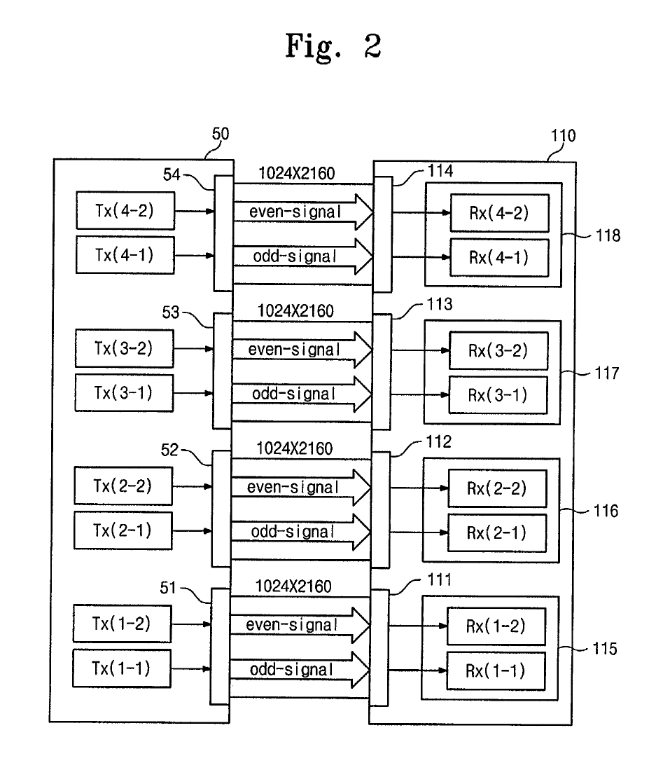

FIG. 2 is a block diagram showing the interface unit 110 and video system 50 of FIG. 1.

Referring to FIG. 2, the interface unit 110 includes first, second, third, and fourth receiving connectors 111, 112, 113, and 114 and first, second, third, and fourth control circuits 115, 116, 117, and 118. Each of the first, second, third, and fourth control circuits 115, 116, 117, and 118 includes two data receivers in order to receive a corresponding image signal group of the image signal groups each including 1024×2160. That is, the interface unit 110 includes eight data receivers Rx(1-1), Rx(1-2), Rx(2-1), Rx(2-2), Rx(3-1), Rx(3-2), Rx(4-1), and Rx(4-2) in total.

The video system 50 interfaced with the display unit 120 by the interface unit 110 includes first, second, third, and fourth transmitting connectors 51, 52, 53, and 54 that are electrically connected to the first, second, third, and fourth receiving connectors 111, 112, 113, and 114, respectively. Each of the first, second, third, and fourth transmitting connectors 51, 52, 53, and 54 receives a corresponding image signal group having 1024×2160 image signals from two corresponding data transmitters. For this data transmission operation, the video system 50 includes eight data transmitters Tx(1-1), Tx(1-2), Tx(2-1), Tx(2-2), Tx(3-1), Tx(3-2), Tx(4-1), and Tx(4-2) in total.

As shown in FIG. 2, each of the first to fourth receiving connectors 111, 112, 113, and 114 receives the corresponding image signal group having 1024×2160 through two channels. Particularly, odd-numbered image signals of 1024×2160 image signals are input through a first channel of each receiving connector 111, 112, 113, and 114, and even-numbered image signals of 1024×2160 image signals are input through a second channel of each receiving connector 111, 112, 113, and 114. Although not shown in FIG. 2, the odd-numbered image signals are applied to odd-numbered data lines of data lines formed on the display panel, and the even-numbered image signals are applied to even-numbered data lines of the data lines.

Each of the first to fourth control circuits 115, 116, 117, and 118 may further include a data processor (not shown) that processes the image signal groups applied through the data receivers and a control signal processor (not shown) that processes various control signals.

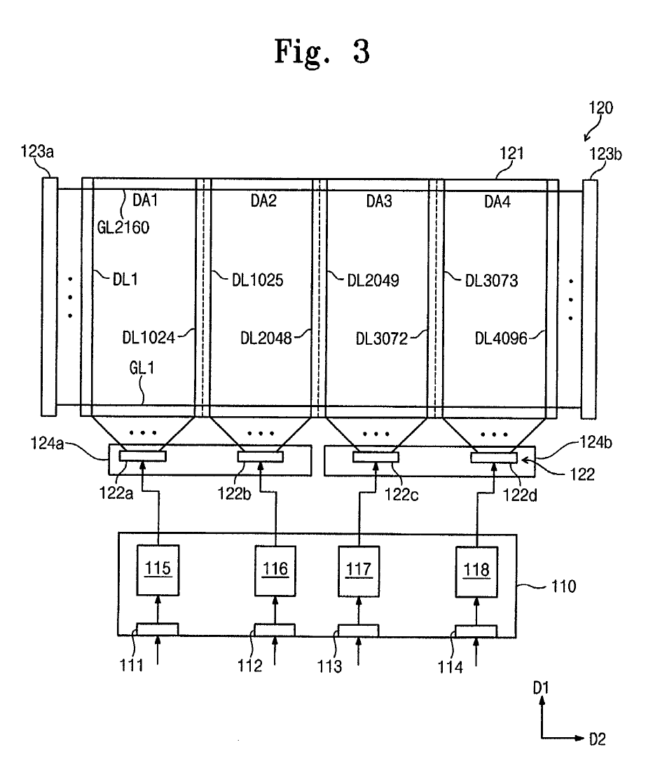

FIG. 3 is a block diagram showing a connection between display unit 130 and interface unit 110 of FIG. 1.

Referring to FIG. 3, the display unit 120 includes the display panel 121 that displays the images. The display panel 121 includes a plurality of data lines DL1˜DL4096 extending in a first direction D1 and a plurality of gate lines GL1˜GL2160 extending in a second direction D2 perpendicular to the first direction D1.

Further, the display panel 121 includes a plurality of pixels that are respectively arranged in pixel areas defined by the data lines DL1˜DL4096 and the gate lines GL1˜GL2160. The pixels are arranged corresponding to red, green, and blue colors (not shown), respectively. As an example of the present invention, the display panel 121 has a resolution of 4096×2160. Accordingly, 4096 pixels may be arranged in every row of the display panel 121 and 2160 pixels may be arranged in every column of the display panel 121.

When the display panel 121 is divided into four equal areas as first, second, third, and fourth display areas DA1, DA2, DA3, and DA4 that are parallel to each other and sequentially arranged along the second direction D2, each of the first to fourth display areas DA1, DA2, DA3, and DA4 has a resolution of 1024×2160. That is, in each of the first to fourth display areas DA1, DA2, DA3, and DA4, 1024 pixels may be arranged in every row and 2160 pixels may be arranged in every column.

The display unit 120 may further include a data driver unit 122 and a gate driver unit 123 (123a and 123b) to drive the pixels formed on the display panel 121.

The data driver unit 122 includes first, second, third, and fourth data drivers 122a, 122b, 122c, and 122d that are electrically connected to the first, second, third, and fourth control circuits 121, 122, 123 (123a and 123b), and 124 (124a and 124b) in the interface unit 110 to receive the first, second, third, and fourth image signal groups, respectively. Each of the first to fourth data drivers 122a, 122b, 122c, and 122d converts the corresponding image signal groups which are in digital form into data signal groups which are in analog form and applies the corresponding data signal groups to the 1024 data lines in a corresponding display area of the first to fourth display areas DA1, DA2, DA3, and DA4.

In the present exemplary embodiment, the interface unit 110 may be mounted on one control board, the first and second data drivers 122a and 122b may be mounted on a first printed circuit board 124a, and the third and fourth data drivers 122c and 122d may be mounted on a second printed circuit board 124b.

The gate driver unit 123 includes a first gate driver 123a and a second gate driver 123b. The first and second gate drivers 123a and 123b are electrically connected to both ends of the gate lines GL1˜GL2160, respectively, and sequentially output a gate signal to the gate lines GL1˜GL2160. The first and second gate drivers 123a and 123b may alternately output the gate signal to the gate lines GL1˜GL2160 or simultaneously output the gate signal to the gate lines GL1˜GL2160. The first and second gate drivers 123a and 123b may be mounted on the display panel 121 in a chip package, or may be formed directly on the display panel 121 through a thin film process.

As shown in FIG. 3, when the display panel 121 having the ultra high-definition resolution is divided into N (wherein N is a natural number equal to or greater than 2) equal areas along the data line direction (i.e., the first direction D1), each area has a resolution reduced by 1/N in comparison with the resolution before the display panel 121 is divided into the N equal areas. Thus, the N display areas may be independently operated when the image signals are independently input according to the N display areas from the video system 50.

In general, the frequency of the interface unit 110 increases according to the resolution of the display panel 121. For instance, an interface unit having a frequency of about 63 MHz is required in order to operate a display panel having a resolution of 1366×768, an interface unit having a frequency of about 124 MHz is required in order to operate a display panel having a resolution of 1920×1080, and an interface unit having a frequency of about 530 MHz is required in order to operate a display panel having a resolution of 4096×2160.

However, the display panel 121 is divided into four equal areas such as first, second, third, and fourth display areas DA1, DA2, DA3, and DA4 each having the resolution of 1024×2160, and the image signals corresponding to each of the first to fourth display areas DA1, DA2, DA3, and DA4 are independently provided to the first to fourth display areas DA1, DA2, DA3, and DA4 through different interface units. Thus, the display apparatus 100 may be operated by using an interface unit having a frequency corresponding to ¼ of 530 MHz without increasing the frequency of the interface unit to 530 MHz.

Also, when the display panel 121 is divided into N equal areas along the scanning direction (i.e., the first direction D1) such that the N display areas are sequentially arranged along the second direction D2, the N display areas may be simultaneously scanned, thereby sequentially applying the image signals to the N display areas, respectively, according to the order of input from the video system 50. On the contrary, when the display panel 121 is divided into N equal areas along the second direction D2 perpendicular to the scanning direction, scanning timings for the N display areas are different from each other. As a result, additional memories are required to store the image signals until the point when a corresponding area of the N display areas to the image signals is to be scanned. Therefore, according to the above-described exemplary embodiment, the display panel 121 is divided along the scanning direction, to thereby prevent the memories from being added to the display panel 121.

Although not shown in the figures, in the case that the display apparatus 100 employs a dual digital visual interface type as the interface unit 110, the display panel 121 is divided into two equal display areas that may be independently operated. In other words, a display panel having a resolution of 4096×2160 is divided into two equal display areas each having a resolution of 2048×2160, and 2048×2160 image signals are applied to each of the display areas through a separate interface unit. Thus, since 4096×2160 image signals are transmitted after being divided into two groups, the 4096×2160 image signals may be transmitted in a frequency that is lower by approximately 0.5 times than the frequency applied to a conventional display panel, thereby preventing the increase of the frequency of the interface unit.

Meanwhile, a display panel having a resolution of 3840×2160 may be divided into two equal display areas or four equal display areas along the scanning direction according to the type of interface unit, and thus each region may be independently operated in order to prevent increase of the number of interface units.

According to the display apparatus and the driving method thereof, in order to drive the display panel having an ultra high-definition resolution, the display panel is divided into N display areas along the scanning direction. Also, the image signals are applied to each of the display areas through the independent interface units, respectively. Thus, the number of the interface units may be prevented from increasing, and no additional memories are required.

Although the exemplary embodiments of the present invention have been described, it is understood that the present invention should not be limited to these exemplary embodiments but various changes and modifications can be made by one ordinarily skilled in the art within the spirit and scope of the present invention as hereinafter claimed.

What is claimed is:

1. A display apparatus comprising:
an interface unit receiving N image signal groups each including i×j image signals from an external video system, wherein N is a natural number equal to or greater than 2; and
a display panel comprising:
a plurality of data lines;
a plurality of gate lines;
a plurality of pixels to display an image; and
wherein the display panel is divided into N display areas each having a resolution of i×j, the N display areas displaying data signals corresponding to the N image signal groups input through the N interface units, and the N display areas are sequentially arranged along a direction in which the gate lines are extended.

2. The display apparatus of claim 1, wherein the display panel has a resolution of (n×i)×j, wherein the (n×i) represents a number of horizontal pixels of the display panel, and further wherein the j represents a number of vertical pixels of the display panel.

3. The display apparatus of claim 2, wherein the n×i is 4096 and the j is 2160.

4. The display apparatus of claim 3, wherein the n is 4 and the i is 1024.

5. The display apparatus of claim 1, wherein each of the N interface units comprises:
a connector receiving a corresponding image signal group of the image signal groups from the video system; and
a data receiver connected to the connector to receive the corresponding image signal group.

6. The display apparatus of claim 5, wherein the connector is a two-channel connector.

7. The display apparatus of claim 6, wherein:
the connector receives odd-numbered image signals of the image signals from the corresponding image signal group through a first channel thereof; and
the connector receives even-numbered image signals of the image signals from the corresponding image signal group through a second channel thereof.

8. The display apparatus of claim 7, wherein the data receiver comprises:
a first data receiver connected to the first channel of the connector; and
a second data receiver connected to the second channel of the connector.

9. The display apparatus of claim 5, wherein each of the N interface units receives data through a low-voltage differential signaling (LVDS) interface type.

10. The display apparatus of claim 1, further comprising:
a gate driver sequentially applying a gate signal to the gate lines;
N data drivers respectively connected to N data line groups arranged in the N display areas to apply data signals to each of the N data line groups.

11. A method of driving a display apparatus, comprising:
receiving N image signal groups each including i×j image signals in parallel;
converting the N image signal groups into N data signal groups;
applying the N data signal groups to N display areas each having a resolution of i×j, respectively;
sequentially applying a gate signal to the N display areas; and
displaying simultaneously images corresponding to the N data signal groups in the N display areas, respectively, in response to the gate signal.

12. The method of claim 11, wherein a display panel on which the N display areas are defined has a resolution of (n×i)×j, wherein the (n×i) represents a number of pixels arranged in a direction in which gate lines are extended from the display panel, and further wherein the j represents a number of pixels arranged in a direction in which data lines are extended from the display panel.

13. The method of claim 12, wherein the N display areas are defined by dividing the display panel along the direction parallel to the data lines and sequentially arranged along the direction in which the gate lines are extended.

14. The method of claim 12, wherein the n×i is 4096 and the j is 2160.

15. The method of claim 14, wherein the n is 4 and the i is 1024.

16. The method of claim 11, wherein the N image signal groups are input through a low-voltage differential signaling (LVDS) interface type.
